(19) United States
(12) Patent Application Publication
(10) Pub. No.: US 2026/0027983 A1
(43) Pub. Date: Jan. 29, 2026

(54) IN-VEHICLE SYSTEM, STATE MANAGEMENT DEVICE, AND CONTROL METHOD

(71) Applicants: AutoNetworks Technologies, Ltd., Yokkaichi-shi (JP); Sumitomo Wiring Systems, Ltd., Yokkaichi-shi (JP); Sumitomo Electric Industries, Ltd., Osaka (JP); TOYOTA JIDOSHA KABUSHIKI KAISHA, Toyota-shi (JP)

(72) Inventors: Yuki SANO, Yokkaichi-shi (JP); Kentaro TANI, Yokkaichi-shi (JP); Takuma YAMANE, Yokkaichi-shi (JP); Ryousuke TAKAHASHI, Toyota-shi (JP)

(73) Assignees: AutoNetworks Technologies, Ltd., Yokkaichi-shi (JP); Sumitomo Wiring Systems, Ltd., Yokkaichi-shi (JP); Sumitomo Electric Industries, Ltd., Osaka (JP); TOYOTA JIDOSHA KABUSHIKI KAISHA, Toyota-shi (JP)

(21) Appl. No.: 19/279,146

(22) Filed: Jul. 24, 2025

(30) Foreign Application Priority Data
Jul. 26, 2024 (JP) 2024-120875

(51) Int. Cl. B60R 16/023; H04W 4/48

(52) U.S. Cl. CPC B60R 16/0231; H04W 4/48

(57) ABSTRACT

An in-vehicle system includes: a first in-vehicle device that transitions from a standby state to an activated state through reception of a frame; a second in-vehicle device; and a state management device. The first in-vehicle device transmits a first activation completion notification when the first in-vehicle device has transitioned from the standby state to the activated state. The state management device includes a first determination unit configured to determine whether or not the first activation completion notification has been received, and a first transmission unit configured to transmit a first state notification when the first determination unit has determined that the first activation completion notification has been received. When having received the first state notification, the second in-vehicle device starts a first communication interruption determination process of determining whether or not communication interruption has occurred in the first in-vehicle device.

### CROSS-REFERENCE TO RELATED APPLICATIONS

This application claims priority on Japanese Patent Application No. 2024-120875 filed on Jul. 26, 2024, the entire content of which is incorporated herein by reference.

### TECHNICAL FIELD

The present disclosure relates to an in-vehicle system, a state management device, and a control method.

### BACKGROUND

In a vehicle, various types of in-vehicle devices such as control-related ECUs (Electronic Control Units) that control an engine, a transmission, and the like, body-related ECUs that control a headlight, a power window, and the like, and information-related ECUs for a navigation device, a multimedia apparatus, and the like are installed. The in-vehicle devices are connected to an in-vehicle network and can communicate with each other.

PATENT LITERATURE 1 (Japanese Laid-Open Patent Publication No. JP 2013-011192 discloses an engine control ECU that performs failure detection and communication with respect to an immobilizer control ECU that is supplied with power from a battery only via an IG switch. The engine control ECU disclosed in JP 2013-011192 is supplied with power from the battery via, in addition to the IG switch, a main relay having a self-holding function and inserted in parallel with the IG switch. This engine control ECU prohibits failure detection when the IG switch has been turned off, thereby preventing erroneous detection due to misalignment of power-supply-off-timing caused by the self-holding function of the main relay.

In recent years, there have been new types of ECUs that are compatible with an NM (network management) function in which ECUs in an identical network are synchronized through transmission and reception of a frame, thereby causing the ECUs to transition from a standby state to an activated state. However, the engine control ECU disclosed in JP 2013-011192 is compatible only with conventional ECUs that are switched between stop and activation by a relay (IG switch), and is not compatible with the new types of ECUs.

### SUMMARY

According to the present disclosure, it is possible to start communication interruption determination with respect to an in-vehicle device that is activated through communication.

An in-vehicle system according to an aspect of the present disclosure includes: a first in-vehicle device that transitions from a standby state to an activated state through reception of a frame; a second in-vehicle device configured to be able to communicate with the first in-vehicle device; and a state management device configured to be able to communicate with the first in-vehicle device and the second in-vehicle device. The first in-vehicle device transmits a first activation completion notification when the first in-vehicle device has transitioned from the standby state to the activated state. The state management device includes a first determination unit configured to determine whether or not the first activation completion notification transmitted from the first in-vehicle device has been received, and a first transmission unit configured to transmit a first state notification when the first determination unit has determined that the first activation completion notification has been received. When having received the first state notification transmitted from the state management device, the second in-vehicle device starts a first communication interruption determination process of determining whether or not communication interruption has occurred in the first in-vehicle device.

### BRIEF DESCRIPTION OF DRAWINGS

FIG. 1 shows an example of a configuration of an in-vehicle system according to an embodiment.

FIG. 2 is a block diagram showing an example of a hardware configuration of a gateway device according to the embodiment.

FIG. 3 is a function block diagram showing an example of a function of the gateway device according to the embodiment.

FIG. 4 is a schematic diagram showing a frame format of CAN.

FIG. 5 is a flowchart showing an example of a state management process in the gateway device according to the embodiment.

FIG. 6 is a sequence diagram for describing an example of a state management operation with respect to a power supply activation-type ECU in the in-vehicle system according to the embodiment.

FIG. 7 is a sequence diagram for describing an example of a state management operation with respect to a communication activation-type ECU in the in-vehicle system according to the embodiment.

### DETAILED DESCRIPTION OF PREFERRED EMBODIMENTS

In the following, the outline of an embodiment of the present disclosure will be listed and described.

In a first aspect, an in-vehicle system according to the present embodiment includes: a first in-vehicle device that transitions from a standby state to an activated state through reception of a frame; a second in-vehicle device configured to be able to communicate with the first in-vehicle device; and a state management device configured to be able to communicate with the first in-vehicle device and the second in-vehicle device. The first in-vehicle device transmits a first activation completion notification when the first in-vehicle device has transitioned from the standby state to the activated state. The state management device includes a first determination unit configured to determine whether or not the first activation completion notification transmitted from the first in-vehicle device has been received, and a first transmission unit configured to transmit a first state notification when the first determination unit has determined that the first activation completion notification has been received. When having received the first state notification transmitted from the state management device, the second in-vehicle device starts a first communication interruption determination process of determining whether or not communication interruption has occurred in the first in-vehicle device. Therefore, it is possible to start the communication interruption determination with respect to the first in-vehicle device that is activated through communication.

In a second aspect according to the first aspect, the first in-vehicle device may transmit a first stop preparation completion notification when the first in-vehicle device transitions from the activated state to the standby state. The state management device may further include a second determination unit configured to determine whether or not the first stop preparation completion notification transmitted from the first in-vehicle device has been received. The transmission unit may transmit a second state notification different from the first state notification when the second determination unit has determined that the first stop preparation completion notification has been received. When having received the second state notification transmitted from the state management device, the second in-vehicle device may end the first communication interruption determination process. Therefore, it is possible to end the communication interruption determination with respect to the first in-vehicle device.

In a third aspect according to the second aspect, the state management device may transmit a state notification frame that includes state information of a plurality of in-vehicle devices. The first state notification may be the state notification frame that includes the state information indicating that the first in-vehicle device is in the activated state. The second state notification may be the state notification frame that includes the state information indicating that the first in-vehicle device is in the standby state. Therefore, by using a common state notification frame, it is possible to start the first communication interruption determination process and end the first communication interruption determination process.

In a fourth aspect according to any one of the first to the third aspects, the in-vehicle system may further include a third in-vehicle device that transitions from a stopped state to an activated state by being supplied with power from a power supply, the third in-vehicle device being configured to be able to communicate with each of the second in-vehicle device and the state management device. The third in-vehicle device may transmit a second activation completion notification when the third in-vehicle device has transitioned from the stopped state to the activated state. The state management device may further include a third determination unit configured to determine whether or not the second activation completion notification transmitted from the third in-vehicle device has been received. The transmission unit may transmit a third state notification different from the first state notification when the third determination unit has determined that the second activation completion notification has been received. When having received the third state notification transmitted from the state management device, the second in-vehicle device may start a second communication interruption determination process of determining whether or not communication interruption has occurred in the third in-vehicle device. Therefore, it is possible to start communication interruption determination with respect to the third in-vehicle device that is activated by the power from the power supply.

In a fifth aspect according to the fourth aspect, the third in-vehicle device may transmit a second stop preparation completion notification when the third in-vehicle device transitions from the activated state to the stopped state. The state management device may further include a fourth determination unit configured to determine whether or not the second stop preparation completion notification transmitted from the third in-vehicle device has been received. The transmission unit may transmit a fourth state notification different from the first state notification and the third state notification when the fourth determination unit has determined that the second stop preparation completion notification has been received. When having received the fourth state notification transmitted from the state management device, the second in-vehicle device may end the second communication interruption determination process. Therefore, it is possible to end the communication interruption determination with respect to the second in-vehicle device.

In a sixth aspect according to the fifth aspect, the state management device may transmit a state notification frame that includes state information of a plurality of in-vehicle devices. The first state notification may be the state notification frame that includes the state information indicating that the first in-vehicle device is in the activated state. The third state notification may be the state notification frame that includes the state information indicating that the third in-vehicle device is in the activated state. The fourth state notification may be the state notification frame that includes the state information indicating that the third in-vehicle device is in the stopped state. Therefore, by using a common state notification frame, it is possible to start each of the first communication interruption determination process and the second communication interruption determination process and end the second communication interruption determination process.

In a seventh aspect according to any one of the first to the sixth aspects, the first in-vehicle device may transmit a specific first frame in a first cycle in the activated state. The first communication interruption determination process may be a process of determining whether or not the first frame has been received in a cycle according to the first cycle. Accordingly, the communication interruption determination of the first in-vehicle device can be performed by using the first frame that is periodically transmitted.

In an eighth aspect according to any one of the fourth to the sixth aspects, the third in-vehicle device may transmit a specific second frame in a second cycle in the activated state. The second communication interruption determination process may be a process of determining whether or not the second frame has been received in a cycle according to the second cycle. Accordingly, the communication interruption determination with respect to the second in-vehicle device can be performed by using the second frame that is periodically transmitted.

In a ninth aspect, a state management device according to the present embodiment includes: a first determination unit configured to determine whether or not a first activation completion notification transmitted from a first in-vehicle device that transitions from a standby state to an activated state through reception of a frame has been received; and a first transmission unit configured to transmit, when the first determination unit has determined that the first activation completion notification has been received, a first state notification which serves as a trigger with which a second in-vehicle device configured to be able to communicate with the first in-vehicle device starts a first communication interruption determination process of determining whether or not communication interruption has occurred in the first in-vehicle device. Therefore, it is possible to start the communication interruption determination with respect to the first in-vehicle device that is activated through communication.

In a tenth aspect, a control method according to the present embodiment includes: a step of transmitting, performed by a first in-vehicle device that transitions from a standby state to an activated state through reception of a frame, a first activation completion notification when the first in-vehicle device has transitioned from the standby state to the activated state; a step of determining, performed by a state management device configured to be able to communicate with the first in-vehicle device and a second in-vehicle device configured to be able to communicate with the first in-vehicle device, whether or not the first activation completion notification transmitted from the first in-vehicle device has been received; a step of transmitting, performed by the state management device, a first state notification when the state management device has determined that the first activation completion notification has been received; and a step of starting, performed by the second in-vehicle device when having received the first state notification transmitted from the state management device, a first communication interruption determination process of determining whether or not communication interruption has occurred in the first in-vehicle device. Therefore, it is possible to start the communication interruption determination with respect to the first in-vehicle device that is activated through communication.

The present disclosure can be realized not only as an in-vehicle system including the characteristic configuration as described above, a state management device included in the in-vehicle system, and a control method including the characteristic steps, but also as a state management program for causing the state management device to execute the characteristic processes, and a part or the entirety of the state management device can be realized as a semiconductor integrated circuit.

Hereinafter, with reference to the drawings, details of an embodiment of the present invention will be described. At least parts of the embodiment described below may be combined as desired.

### In-Vehicle System

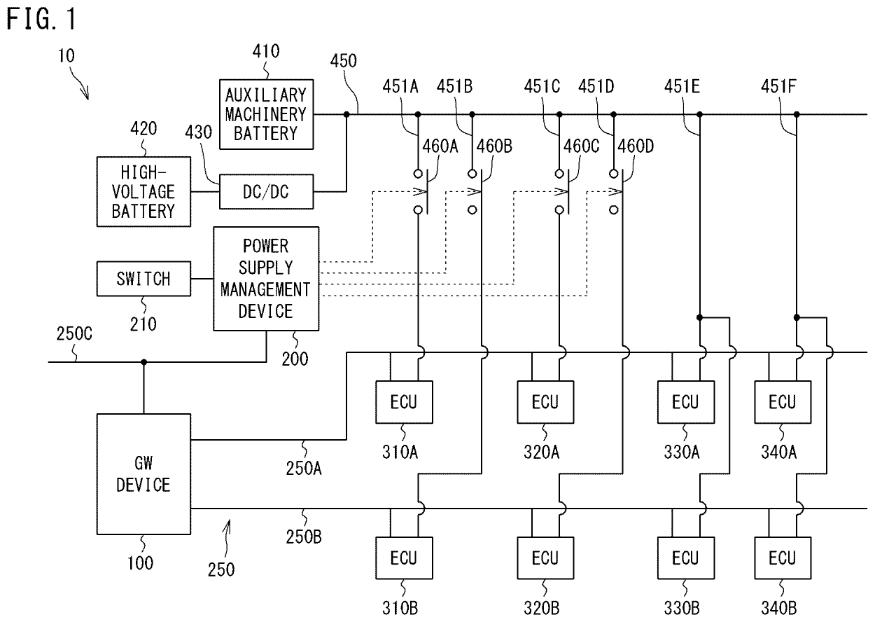

FIG. 1 shows an example of a configuration of an in-vehicle system according to an embodiment.

An in-vehicle system 10 includes a gateway device (hereinafter, referred to as “GW device”) 100, a power supply management device 200, and ECUs 310A, 310B, 320A, 320B, 330A, 330B, 340A, 340B.

The GW device 100 is connected to an in-vehicle network 250. The in-vehicle network 250 according to the embodiment is a CAN (Controller Area Network) network having a bus-type network topology. The in-vehicle network 250 includes buses 250A, 250B, 250C.

The GW device 100, the power supply management device 200, and the ECUs 310A, 310B, 320A, 320B, 330A, 330B, 340A, 340B use a communication protocol for periodically or non-periodically transmitting and receiving a frame. In the embodiment, the communication protocol is CAN or CAN FD (CAN with Flexible Data Rate).

The bus 250A has the ECUs 310A, 320A, 330A, 340A connected thereto. The bus 250B has the ECUs 310B, 320B, 330B, 340B connected thereto. Each of the ECUs 310A, 310B, 320A, 320B, 330A, 330B, 340A, 340B includes a CAN interface, and can perform communication according to CAN.

Each of the ECUs 310A, 310B, 320A, 320B, 330A, 330B, 340A, 340B is disposed in a component of the vehicle. Each of the ECUs 310A, 310B, 320A, 320B, 330A, 330B, 340A, 340B individually controls the hardware of components of the vehicle, and monitors the state of the hardware of components of the vehicle. For example, each of the ECUs 310A, 310B, 320A, 320B, 330A, 330B, 340A, 340B is one of control-related, body-related, and information-related ECUs.

Each of the ECUs 310A, 310B, 320A, 320B, 330A, 330B, 340A, 340B has a function of providing a service. One service can be provided by one or a plurality of ECUs. For example, a smart entry service is provided by an ECU group that includes the ECUs 330A and 330B. For example, a forward vehicle following service is provided by an ECU group that includes the ECUs 320A and 320B.

In the example in FIG. 1, the ECUs 310A, 310B, 320A, 320B are old-type ECUs and the ECUs 330A, 330B, 340A, 340B are new-type ECUs. The ECUs 310A, 310B, 320A, 320B are an example of “third in-vehicle device”, and the ECUs 330A, 330B, 340A, 340B are an example of “first in-vehicle device”. Hereinafter, the old-type ECUs 310A, 310B, 320A, 320B will also be referred to as “power supply activation-type ECU”, and the new-type ECUs 330A, 330B, 340A, 340B will also be referred to as “communication activation-type ECU”.

The old-type ECU does not have the NM function. The old-type ECU has two states, i.e., a stopped state and an activated state.

The new-type ECU has the NM function. The new-type ECU has two states, i.e., a standby state (sleep state) and an activated state. When having received an NM frame in the standby state, the new-type ECU transitions from the standby state to the activated state.

The bus 250C has the power supply management device 200 connected thereto. For example, the power supply management device 200 includes a CAN interface, and can perform communication according to CAN.

The GW device 100 is connected to the buses 250A, 250B, 250C. As described later, the GW device 100 includes a CAN interface, and can perform communication according to CAN.

The GW device 100 has a communication relaying function. That is, the GW device 100 can relay communication (frame) between the buses 250A, 250B, 250C.

In the vehicle, an auxiliary machinery battery 410, a high-voltage battery 420, and a DC/DC converter 430 are installed as the power supply. The auxiliary machinery battery 410 is a battery having an output voltage of 12 V, for example, and is used for driving auxiliary machinery such as ECUs. The high-voltage battery 420 is a battery having an output voltage of 400 V, for example, and is used for vehicle travelling. The DC/DC converter 430 is connected to the high-voltage battery 420, and steps down the output voltage from the high-voltage battery 420 to 12 V. The output side of the DC/DC converter 430 is connected to a power line 450 extending from the auxiliary machinery battery 410, and by using the output power from the DC/DC converter 430, it is possible to charge the auxiliary machinery battery 410 and to feed power to each of the ECUs 310A, 310B, 320A, 320B, 330A, 330B, 340A, 340B.

The power line 450 extending from the auxiliary machinery battery 410 is connected to respective power lines 451A, 451B, 451C, 451D, 451E, 451F at a plurality of places. The power line 451A is connected to the ECU 310A. The power line 451A is provided with a relay 460A. The power line 451B is connected to the ECU 310B. The power line 451B is provided with a relay 460B. The power line 451C is connected to the ECU 320A. The power line 451C is provided with a relay 460C. The power line 451D is connected to the ECU 320B. The power line 451D has a relay 460D connected thereto. The power line 451E branches midway, and the branches are connected to the ECUs 330A and 330B, respectively. The power line 451E is not provided with a relay. The power line 451F branches midway, and the branches are connected to the ECUs 340A and 340B, respectively. The power line 451F is not provided with a relay.

The power supply management device 200 manages activation and stop of the ECUs 310A, 310B, 320A, 320B. In a specific example, the power supply management device 200 individually switches the relays 460A, 460B, 460C, and 460D between an ON state (connected state) and an OFF state (disconnected state). When the relay 460A enters an ON state, power is supplied to the ECU 310A, and the ECU 310A is activated. When the relay 460A enters an OFF state, power supply to the ECU 310A is stopped, and the ECU 310A stops. When the relay 460B enters an ON state, power is supplied to the ECU 310B, and the ECU 310B is activated. When the relay 460B enters an OFF state, power supply to the ECU 310B is stopped, and the ECU 310B stops. When the relay 460C enters an ON state, power is supplied to the ECU 320A, and the ECU 320A is activated. When the relay 460C enters an OFF state, power supply to the ECU 320A is stopped, and the ECU 320A stops. When the relay 460D enters an ON state, power is supplied to the ECU 320B, and the ECU 320B is activated. When the relay 460D enters an OFF state, power supply to the ECU 320B is stopped, and the ECU 320B stops.

### Vehicle State

In the following, a vehicle state according to the embodiment will be described. The vehicle state according to the embodiment includes a first vehicle state and a second vehicle state.

### First Vehicle State

The first vehicle state is a vehicle state for activating and stopping the old-type ECU. The first vehicle state includes states of +B, ACC, and IG.

The power supply management device 200 has a switch 210 connected thereto. The switch 210 is used in order to switch the first vehicle state between +B, ACC, and IG. The switch 210 is a push switch, for example.

When the switch 210 is pressed (ON) during +B, the state transitions from +B to ACC. When the switch 210 is pressed during ACC, the state transitions from ACC to IG. When the switch 210 is pressed during IG, the state transitions from IG to +B.

The first vehicle state determines the state of the old-type ECU. During +B, power is supplied to the ECUs 330A, 330B. During +B, each of the relays 460A, 460B, 460C, 460D is in an OFF state, and power is not supplied to the ECUs 310A, 310B, 320A, 320B. That is, during +B, the ECUs 310A, 310B, 320A, 320B are in a stopped state.

When transition from +B to ACC has been made, the relays 460A, 460B switch from OFF to ON. During ACC, power is supplied to the ECUs 310A, 310B by the auxiliary machinery battery 410 (and the DC/DC converter 430) serving as the power supply, and the ECUs 310A, 310B are activated. The ECUs 330A, 330B are always supplied with power, and thus can be activated also during ACC. During ACC, the relays 460C, 460D are in an OFF state, and power is not supplied to the ECUs 320A, 320B. That is, during ACC, the ECUs 320A, 320B are in a stopped state.

When transition from ACC to IG has been made, the relays 460C, 460D switch from OFF to ON. During IG, power is supplied to the ECUs 320A, 320B by the auxiliary machinery battery 410 (and the DC/DC converter 430) serving as the power supply, and the ECUs 320A, 320B are activated. The ECUs 330A, 330B are always supplied with power, and thus can be activated also during IG. Further, since the relays 460A, 460B maintain the ON state also during IG, the ECUs 310A, 310B are activated also during IG. The power supply management as described above is an example and is not limited thereto. For example, ON/OFF of the relays 460A, 460B, 460C, 460D may be individually switched in accordance with the state of the vehicle or the surroundings of the vehicle.

### Second Vehicle State

The second vehicle state is a vehicle state for activating and stopping the new-type ECU. The vehicle has installed therein an input device that receives various instructions from a user (occupant), and various types of sensors that detect an object or the state of the vehicle or the surroundings of the vehicle (these are not shown). The input device is a touch sensor mounted to a display disposed at a dashboard, for example. In another example, the input sensor is a switch provided to the dashboard, the steering wheel, or the like of the vehicle. The sensors are, for example, a camera, a radar, a LiDAR, a human presence sensor, a seat occupancy sensor, a shift position sensor, a hydraulic sensor, a temperature sensor, a vehicle speed sensor, an engine (or motor) rotation speed sensor, an accelerator pedal stroke sensor, a brake pedal stroke sensor, a steering angle sensor, etc.

The second vehicle state includes states such as a vehicle standby state, an unmanned parking state, a manned parking state, and a manned traveling state, for example.

The vehicle standby state is a state where the vehicle is stopped. In the vehicle standby state, only the minimum number of sensors and ECUs are activated. The power supply (the auxiliary machinery battery 410 and the DC/DC converter 430) has the new-type ECUs 340A, 340B always connected thereto. Therefore, power is always supplied to the ECUs 340A, 340B. In the vehicle standby state, the ECUs 340A, 340B are in a standby state. The standby state of the new-type ECUs 340A, 340B is a state where only the minimum functions are in operation and almost all functions are stopped. Specifically, in the standby state, the CAN interfaces of the ECUs 340A, 340B, the input device that receives an instruction from the user, and sensors that detect the state of the vehicle and the state of the surroundings of the vehicle or an object in the surroundings of the vehicle are in operation, and the processor is stopped. That is, the standby state of the ECUs 340A, 340B is a power-saving state where power consumption is suppressed.

The unmanned parking state is a vehicle state where an unmanned parking service is executed. That is, the unmanned parking state is a state where an ECU group that provides the unmanned parking service is activated. The unmanned parking service includes a smart entry service, for example.

For example, the unmanned parking state starts upon reception of an instruction of execution start of the unmanned parking service from the user. For example, when the GW device 100 has received an instruction of execution start of the unmanned parking service in the vehicle standby state, the state transitions from the vehicle standby state to the unmanned parking state.

For example, the in-vehicle network has implemented therein a partial network function in which: the in-vehicle network is divided into clusters, each referred to as a PNC (Partial Network Cluster), for respective functions (services); ECUs belonging to the PNC to be used in execution of a service are woken up; and ECUs of the other PNCs are caused to sleep. The NM frame includes designation of a PNC to be woken up (activated), ECUs having received the NM frame each wake up when the designated PNC matches the PNC to which the device belongs, and maintain “sleep” when the designated PNC does not match the PNC to which the device belongs.

For example, a certain new-type ECU, when having received an instruction of execution start of the unmanned parking service, transmits an NM frame designating a PNC corresponding to the unmanned parking service, to the bus to which the ECU is connected. Upon reception of the NM frame transmitted through the above-described bus, the GW device 100 relays the NM frame to the bus to which the ECU belonging to the PNC designated in the NM frame is connected. Upon reception of the NM frame, the ECU belonging to the PNC corresponding to the unmanned parking service transitions from the standby state to the activated state. Accordingly, the second vehicle state transitions to the unmanned parking state.

For example, the smart entry service is executed by an image processing ECU that processes an image from a camera that captures an image of the outside of the vehicle, and a door lock control ECU that controls locking and unlocking of a door. In the smart entry service, an image of the periphery of the vehicle is captured by the camera, and face recognition is executed by the image processing ECU. When user recognition by the face recognition has succeeded and contact with a door handle has been detected, the door lock control ECU unlocks the door.

The manned parking state is a vehicle state where a manned parking service is executed. That is, the manned parking state is a state where the ECU group that provides the manned parking service is activated. The manned parking service includes an audio/visual service (hereinafter, also referred to as “AV service”), for example.

For example, the manned parking state starts when seat occupancy has been detected by a seat occupancy sensor provided to a seat in the unmanned parking state. For example, when seat occupancy has been detected in the unmanned parking state, a certain new-type ECU transmits an NM frame designating a PNC corresponding to the manned parking service, to the bus to which the ECU is connected. Upon reception of the NM frame transmitted through the above-described bus, the GW device 100 relays the NM frame to the bus to which the ECU belonging to the PNC designated in the NM frame is connected. Upon reception of the NM frame, the ECU belonging to the PNC corresponding to the manned parking service transitions from the standby state to the activated state. Accordingly, the second vehicle state transitions to the manned parking state.

For example, the AV service is executed by a multimedia ECU. In the AV service, content such as music or video is played by the multimedia ECU.

The manned traveling state is a vehicle state where a manned traveling service is executed. That is, the manned traveling state is a state where the ECU group that provides the manned traveling service is activated. The manned traveling service includes the forward vehicle following service that enables traveling while the inter-vehicle distance from the vehicle ahead is maintained, for example.

For example, the manned traveling state starts when movement of the shift lever from the P-range to the D-range has been detected by the shift position sensor in the manned parking state. For example, when movement of the shift lever to the D-range has been detected in the manned parking state, a certain new-type ECU transmits an NM frame designating a PNC corresponding to the manned traveling service, to the bus to which the ECU is connected. Upon reception of the NM frame transmitted through the above-described bus, the GW device 100 relays the NM frame to the bus to which the ECU belonging to the PNC designated in the NM frame is connected. Upon reception of the NM frame, the ECU belonging to the PNC corresponding to the manned traveling service transitions from the standby state to the activated state. Accordingly, the second vehicle state transitions to the manned traveling state.

For example, the forward vehicle following service is executed by an inter-vehicle distance detection ECU connected to a LiDAR or a camera, an image processing ECU that detects a lane in an image of the area in front of the vehicle obtained by the camera, a steering ECU that controls the steering wheel, and an engine ECU (or a motor ECU that controls a traveling motor) that controls the engine. In the forward vehicle following service, the steering angle (tire angle) and the vehicle speed of the vehicle are controlled such that the vehicle does not deviate from the lane detected by the image processing ECU in a state where the inter-vehicle distance from the forward vehicle is maintained by the inter-vehicle distance detection ECU.

### Hardware Configuration of GW Device

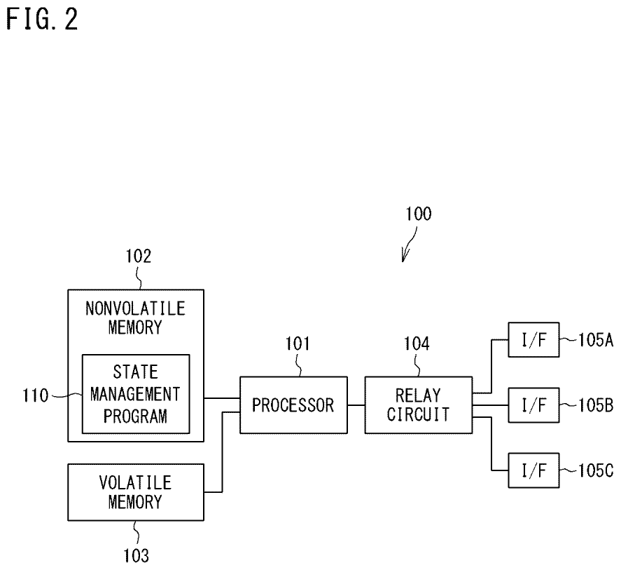

FIG. 2 is a block diagram showing an example of a hardware configuration of the GW device according to the embodiment. The GW device 100 includes a processor 101, a nonvolatile memory 102, a volatile memory 103, a relay circuit 104, and interfaces (hereinafter, also referred to as “I/F”) 105A, 105B, 105C. The processor 101 is connected to the nonvolatile memory 102, the volatile memory 103, and the relay circuit 104 by signal lines. Each of the I/Fs 105A, 105B, 105C is connected to the relay circuit 104 by a signal line.

The volatile memory 103 is a semiconductor memory such as an SRAM (Static Random Access Memory) or a DRAM (Dynamic Random Access Memory), for example. The nonvolatile memory 102 is a flash memory, a hard disk, a ROM (Read Only Memory), or the like, for example. The nonvolatile memory 102 has stored therein a state management program 110 being a computer program and data to be used in execution of the state management program 110. The later-described function of the GW device 100 is realized by the state management program 110 being executed by the processor 101.

The processor 101 is a CPU (Central Processing Unit), for example. However, the processor 101 is not limited to a CPU. The processor 101 may be a GPU (Graphics Processing Unit). In a specific example, the processor 101 is a multi-core processor. The processor 101 may be a single-core processor. The processor 101 is configured to be able to execute computer programs. However, the processor 101 may be an ASIC (Application Specific Integrated Circuit) or may be a programmable logic device such as an FPGA (Field Programmable Gate Array), for example. In this case, the ASIC or the programmable logic device are configured to be able to execute the same function as that of the state management program 110.

The I/Fs 105A, 105B, 105C are each a communication interface (CAN interface) according to CAN. Each of the I/Fs 105A, 105B, 105C includes a transceiver according to CAN. The I/F 105A is connected to the bus 250A, and the I/F 105B is connected to the bus 250B. The I/F 105C is connected to the bus 250C connected to the power supply management device 200.

The relay circuit 104 is a circuit for relaying a CAN frame. For example, the relay circuit 104 determines whether or not a frame received from the bus 250A in the I/F 105A is a frame that should be transferred to the bus 250B or the bus 250C. In the case of a frame that should be transferred to the bus 250B, the relay circuit 104 outputs the frame to the I/F 105B, and in the case of a frame that should be transferred to the bus 250C, the relay circuit 104 outputs the frame to the I/F 105C. The relay circuit 104 determines whether or not a frame received from the bus 250B in the I/F 105B is a frame that should be transferred to the bus 250A or the bus 250C. In the case of a frame that should be transferred to the bus 250A, the relay circuit 104 outputs the frame to the I/F 105A, and in the case of a frame that should be transferred to the bus 250C, the relay circuit 104 outputs the frame to the I/F 105C. The relay circuit 104 determines whether or not a frame received from the bus 250C in the I/F 105C is a frame that should be transferred to the bus 250A or the bus 250B. In the case of a frame that should be transferred to the bus 250A, the relay circuit 104 outputs the frame to the I/F 105A, and in the case of a frame that should be transferred to the bus 250B, the relay circuit 104 outputs the frame to the I/F 105B.

The relay circuit 104 includes a communication circuit according to CAN. When specific data is to be transmitted to at least one of the buses 250A, 250B, 250C, the relay circuit 104 generates a CAN frame in accordance with an instruction from the processor 101, for example, and outputs the CAN frame to at least one of the I/Fs 105A, 105B, 105C. The relay circuit 104 extracts, from a frame received in one of the I/Fs 105A, 105B, 105C, data contained in the frame, and outputs the data to the processor 101. However, a part or the entirety of the function of the relay circuit 104 may be executed by the processor 101.

### Function of GW Device

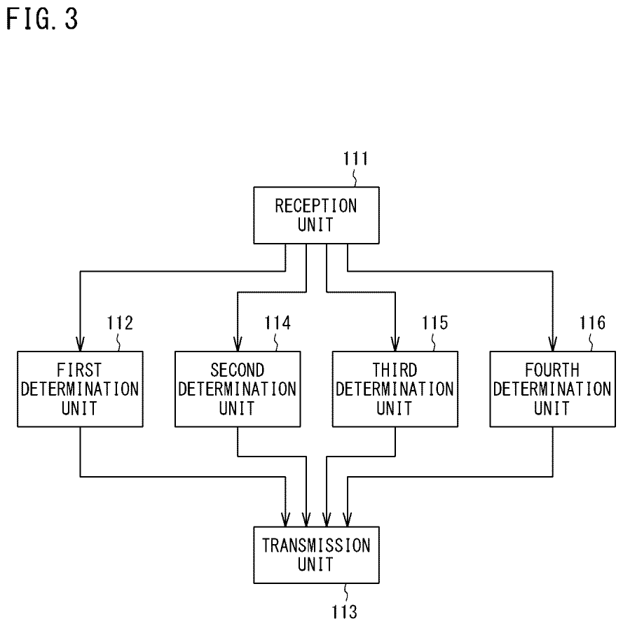

FIG. 3 is a function block diagram showing an example of the function of the GW device according to the embodiment.

The GW device 100 is an example of “state management device”. The processor 101 of the GW device 100 executes the state management program 110, whereby functions of a reception unit 111, a first determination unit 112, a transmission unit 113, a second determination unit 114, a third determination unit 115, and a fourth determination unit 116 are realized.

The reception unit 111 receives a frame transmitted in the in-vehicle network 250.

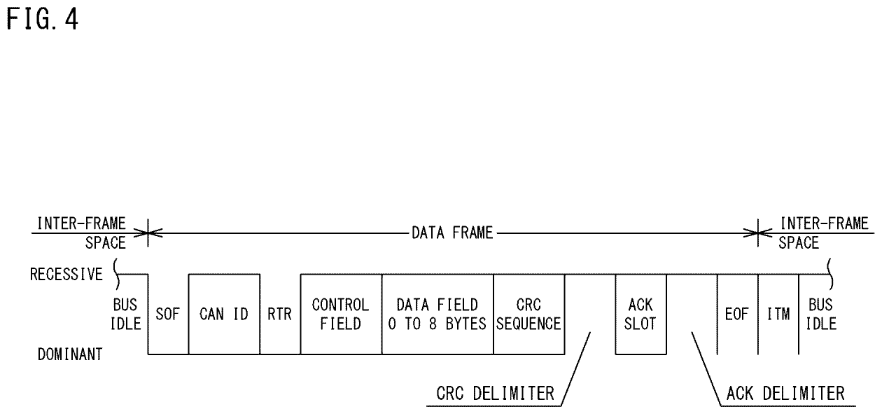

Here, a CAN frame will be described. FIG. 4 is a schematic diagram showing a frame format of CAN. In FIG. 4, a data frame structure of the standard format of CAN is shown. In the drawing, the line on the upper side shows “recessive” and the line on the lower side shows “dominant”. As shown in FIG. 4, the data frame of CAN includes fields of SOF (Start Of Frame), CAN ID, RTR (Remote Transmission Request), control field, data field, CRC (Cyclic Redundancy Check) sequence, CRC delimiter, ACK (Acknowledgement) slot, ACK delimiter, and EOF (End Of Frame). The SOF indicates start of the frame. The CAN ID is used in order to identify the kind of the ECU and the frame. The RTR is used in order to discern between a data frame and a remote frame. In the case of a data frame, the RTR is dominant. In the control field, information to be used in communication control is stored. In the data field, actual data (payload) of a maximum of 8 bytes is stored. The CRC sequence and the CRC delimiter are collectively referred to as a CRC field, and in the CRC field, a kind of error detection code is stored. The ACK slot and the ACK delimiter are collectively referred to as an ACK field, and in the ACK field, information indicating whether or not up to the CRC field portion has been able to be normally received, is stored. The EOF indicates the end of the frame.

In CAN, identification information referred to as a CAN ID is included in a frame. The CAN ID indicates the kind of the frame. For example, the CAN ID of a frame that includes data of “engine rotation speed” is “0x100”, the CAN ID of a frame that includes data of “accelerator opening degree” is “0x200”, etc.

With reference back to FIG. 1, each ECU 310A, 310B, 320A, 320B, 330A, 330B, 340A, 340B executes an activation sequence at the time of activation. The activation sequence is a process for causing the state of the ECU to transition from a state (stopped state, standby state) where the function of the ECU, e.g., a function for controlling hardware, is stopped, to a state (activated state) where the above-described function is exhibited.

When the power supply has been turned on, the power supply activation-type ECU 310A, 310B, 320A, 320B executes the activation sequence and transitions from the stopped state to the activated state. For example, the activation sequence of the power supply activation-type ECU includes a process of executing a boot loader and loading an operating system to a volatile memory, and an activation process of software (hereinafter, also referred to as “application software” or “APP”) for controlling hardware or monitoring the state of the hardware or the state of the periphery of the vehicle. Upon completion of the activation sequence, the ECU 310A, 310B, 320A, 320B transmits an activation completion notification. The activation completion notification transmitted from the power supply activation-type ECU is an example of “second activation completion notification”.

When the communication activation-type ECU 340A, 340B has received an NM frame, has received a specific instruction from the user through the input device, or has detected a specific state of the vehicle, a specific state in the surroundings of the vehicle, or a specific object in the surroundings of the vehicle by a sensor (i.e., a trigger for activation of a specific service has been detected), the communication activation-type ECU 340A, 340B executes the activation sequence and transitions from the standby state to the activated state. The activated ECU 340A, 340B transmits an NM frame designating the PNC of the device in order to activate the other ECUs belonging to the PNC of the device. For example, the activation sequence of the communication activation-type ECU includes a process of restoring, into a volatile memory, working data in the previous activated state saved in a nonvolatile memory. Upon completion of the activation sequence, the ECU 340A, 340B transmits an activation completion notification. The activation completion notification transmitted from the communication activation-type ECU is an example of “first activation completion notification”.

The activation completion notification is a frame that includes information indicating that the state transition to the activated state of the ECU has been completed. In an example, the activation completion notification includes the CAN ID of the frame transmission source (i.e., the ECU for which the activation sequence has been completed), and includes information indicating the activation completion in the data field.

Each ECU 310A, 310B, 320A, 320B executes a stop preparation process when transitioning from the activated state to the stopped state. The stop preparation process is a process for normally stopping the ECU. Each ECU 330A, 330B, 340A, 340B executes a standby preparation process when transitioning from the activated state to the standby state. The standby preparation process is a process for normally shifting the ECU to the standby state.

The power supply activation-type ECU 310A, 310B, 320A, 320B executes the stop preparation process upon reception of a stop instruction from the user caused by the switch 210 being pressed. For example, the stop preparation process performed by the power supply activation-type ECU includes an APP ending process. Upon completion of the stop preparation process, the ECU 310A, 310B, 320A, 320B transmits a stop preparation completion notification. The stop preparation process performed by the power supply activation-type ECU is an example of “second stop preparation process”, and the stop preparation completion notification transmitted from the power supply activation-type ECU is an example of “second stop preparation completion notification”. Upon transmission of the stop preparation completion notification, the ECU 310A, 310B, 320A, 320B quickly transitions to the stopped state.

The communication activation-type ECU 340A, 340B executes the standby preparation process upon reception of a standby instruction provided from the user. For example, the standby preparation process performed by the communication activation-type ECU includes a process of saving, into a nonvolatile memory 202, working data stored in a volatile memory. Upon completion of the standby preparation process, the ECU 340A, 340B transmits a standby preparation completion notification. The standby preparation process performed by the communication activation-type ECU is an example of “first stop preparation process”, and the standby preparation completion notification transmitted from the communication activation-type ECU is an example of “first stop preparation completion notification”. Upon transmission of the standby preparation completion notification, the ECU 340A, 340B quickly transitions to the standby state.

As described above, when the communication activation-type ECU 340A, 340B has transitioned from the standby state to the activated state, the ECU 340A, 340B transmits an activation completion notification. With reference back to FIG. 3, the first determination unit 112 determines whether or not the activation completion notification (first activation completion notification) transmitted from the communication activation-type ECU has been received by the reception unit 111. That is, the first determination unit 112 determines whether or not the frame received by the reception unit 111 is the activation completion notification (first activation completion notification) transmitted from the communication activation-type ECU.

In a specific example, the first determination unit 112 analyzes the frame received by the reception unit 111, and determines whether or not the frame is the activation completion notification transmitted from the communication activation-type ECU. The first determination unit 112 confirms the transmission source of the frame, based on the CAN ID of the received frame, and determines whether or not the transmission source is the communication activation-type ECU. The first determination unit 112 refers to the information stored in the data field of the received frame, and determines whether or not the frame is the activation completion notification. For example, when activation of the ECU 340A has been completed, an activation completion notification including the CAN ID of the ECU 340A and information indicating the activation completion is transmitted. The first determination unit 112 determines that activation of the ECU 340A has been completed, by analyzing the activation completion notification.

When the first determination unit 112 has determined that the activation completion notification (first activation completion notification) transmitted from the communication activation-type ECU has been received, the transmission unit 113 transmits information (first state notification) for making a notification that the communication activation-type ECU has transitioned to the activated state.

The GW device 100 manages the states of all the ECUs in the vehicle. The GW device 100 identifies the state (activated state, stopped state, standby state) of each ECU as described above, and notifies the entire vehicle of the states of all the ECUs. Specifically, the GW device 100 creates a state notification frame. The state notification frame is a frame for notifying all the ECUs in the vehicle of the state of each of all the ECUs in the vehicle.

The state notification frame includes state information of all the ECUs in the data field. For example, the state information is information indicating whether the activated state is “ON” or “OFF”. That is, in the case of the state information about the power supply activation-type ECU, when the ECU is in the activated state, the activated state is “ON”, and when the ECU is in the stopped state, the activated state is “OFF”. In the case of the state information about the communication activation-type ECU, when the ECU is in the activated state, the activated state is “ON”, and when the ECU is in the standby state, the activated state is “OFF”.

In a specific example, in the state notification frame, the state information is stored in association with the identification information of each ECU. Accordingly, in the state notification frame, the state information can be identified for each ECU.

For example, the first state notification is the state notification frame. Specifically, the first state notification is a state notification frame in which the activated state is “ON” in the state information corresponding to the identification information of the target ECU (the transmission source ECU of the activation completion notification). The transmission unit 113 transmits such a state notification frame to all the ECUs. When activation of the ECU 340A has been completed, the identification information of the ECU 340A and the state information in which the activated state is “ON” are associated with each other in the state notification frame. The transmission unit 113 broadcasts the state notification frame, for example. Therefore, it is possible to notify all the ECUs of the ECU 340A being in the activated state. Each ECU can identify the ECU 340A being in the activated state, by analyzing the state notification frame.

When having received the state notification frame (first state notification) transmitted from the GW device 100, an ECU in the activated state (e.g., the ECU 330A) different from the communication activation-type ECU of which the activation has been completed (e.g., ECU 340A) starts a communication interruption determination process with respect to the communication activation-type ECU 340A of which the activation has been completed. The communication interruption determination process with respect to the communication activation-type ECU 340A is a process of determining whether or not communication interruption has occurred in the communication activation-type ECU 340A. In a specific example, the ECU 340A in the activated state transmits a specific frame (first frame) in a specific cycle (first cycle). The specific frame (hereinafter, also referred to as “periodic frame”) is a frame that includes the CAN ID of the ECU 340A, for example. If the periodic frame from the ECU 340A has reached the ECU 330A, it can be determined that the communication between the ECU 330A and the ECU 340A is not interrupted.

The communication interruption determination is a process of determining whether or not the periodic frame has been received in a cycle (hereinafter, also referred to as “determination cycle”) according to the transmission cycle of the periodic frame. The determination cycle is a cycle of an integer multiple of the transmission cycle of the periodic frame, for example. The ECU 330A determines whether or not the periodic frame has been received, for each determination cycle. For example, when the periodic frame is not received at a certain time point and thereafter, the ECU 330A can determine that the communication with the ECU 340A has been interrupted. For example, in a certain cycle, when the periodic frame is not received, and thereafter, the periodic frame is received, the ECU 330A can determine that: a communication failure with the ECU 340A has occurred; but the communication state has been restored.

The second determination unit 114 determines whether or not the standby preparation completion notification (first stop preparation completion notification) transmitted from the communication activation-type ECU has been received by the reception unit 111. That is, the second determination unit 114 determines whether or not the frame received by the reception unit 111 is the standby preparation completion notification (first stop preparation completion notification) transmitted from the communication activation-type ECU.

In a specific example, the second determination unit 114 analyzes the frame received by the reception unit 111, and determines whether or not the frame is the standby preparation completion notification transmitted from the communication activation-type ECU. The second determination unit 114 confirms the transmission source of the frame, based on the CAN ID of the received frame, and determines whether or not the transmission source is the communication activation-type ECU. The second determination unit 114 refers to the information stored in the data field of the received frame, and determines whether or not the frame is the standby preparation completion notification. For example, when the standby preparation process performed by the ECU 340A has been completed, a standby preparation completion notification including the CAN ID of the ECU 340A and information indicating the standby preparation completion is transmitted. The second determination unit 114 determines that the standby preparation process of the ECU 340A has been completed, by analyzing the standby preparation completion notification.

When the second determination unit 114 has determined that the standby preparation completion notification (first stop preparation completion notification) transmitted from the communication activation-type ECU has been received, the transmission unit 113 transmits information (second state notification) for making a notification that the communication activation-type ECU has transitioned to the standby state.

For example, the second state notification is the state notification frame. Specifically, the second state notification is a state notification frame in which the activated state is “OFF” in the state information corresponding to the identification information of the target ECU (the transmission source ECU of the standby preparation completion notification). The transmission unit 113 transmits such a state notification frame to all the ECUs. When the standby preparation process of the ECU 340A has been completed, the identification information of the ECU 340A and the state information in which the activated state is “OFF” are associated with each other in the state notification frame. The transmission unit 113 broadcasts the state notification frame, for example. Therefore, it is possible to notify all the ECUs of the ECU 340A being in the standby state. Each ECU can identify the ECU 340A being in the standby state, by analyzing the state notification frame.

When having received the state notification frame (second state notification) transmitted from the GW device 100, the ECU in the activated state (e.g., the ECU 330A) ends the communication interruption determination process with respect to the communication activation-type ECU 340A for which the standby preparation process has been completed. Therefore, it is possible to end the communication interruption determination process with respect to the ECU 340A at the timing when the ECU 340A transitions to the standby state.

The third determination unit 115 determines whether or not the activation completion notification (second activation completion notification) transmitted from the power supply activation-type ECU has been received by the reception unit 111. That is, the third determination unit 115 determines whether or not the frame received by the reception unit 111 is the activation completion notification (second activation completion notification) transmitted from the power supply activation-type ECU.

In a specific example, the third determination unit 115 analyzes the frame received by the reception unit 111, and determines whether or not the frame is the activation completion notification transmitted from the power supply activation-type ECU. The third determination unit 115 confirms the transmission source of the frame, based on the CAN ID of the received frame, and determines whether or not the transmission source is the power supply activation-type ECU. The third determination unit 115 refers to the information stored in the data field of the received frame, and determines whether or not the frame is the activation completion notification. For example, when activation of the ECU 310A has been completed, an activation completion notification including the CAN ID of the ECU 310A and information indicating the activation completion is transmitted. The third determination unit 115 determines that activation of the ECU 310A has been completed, by analyzing the activation completion notification.

When the third determination unit 115 has determined that the activation completion notification (second activation completion notification) transmitted from the power supply activation-type ECU has been received, the transmission unit 113 transmits information (third state notification) for making a notification that the power supply activation-type ECU has transitioned to the activated state.

For example, the third state notification is the state notification frame. Specifically, the third state notification is a state notification frame in which the activated state is “ON” in the state information corresponding to the identification information of the target ECU (the transmission source ECU of the activation completion notification). The transmission unit 113 transmits such a state notification frame to all the ECUs. When activation of the ECU 310A has been completed, the identification information of the ECU 310A and the state information in which the activated state is “ON” are associated with each other in the state notification frame. The transmission unit 113 broadcasts the state notification frame, for example. Therefore, it is possible to notify all the ECUs of the ECU 310A being in the activated state. Each ECU can identify the ECU 310A being in the activated state, by analyzing the state notification frame.

When having received the state notification frame (third state notification) transmitted from the GW device 100, an ECU in the activated state (e.g., the ECU 330A) different from the power supply activation-type ECU of which the activation has been completed (e.g., ECU 310A) starts a communication interruption determination process with respect to the power supply activation-type ECU 310A of which the activation has been completed. The communication interruption determination process with respect to the power supply activation-type ECU 310A is a process of determining whether or not communication interruption has occurred in the communication activation-type ECU 310A. In a specific example, the ECU 310A in the activated state transmits a specific frame (second frame) in a specific cycle (second cycle). The specific frame (periodic frame) is a frame that includes the CAN ID of the ECU 310A, for example. If the periodic frame from the ECU 310A has reached the ECU 330A, it can be determined that the communication between the ECU 330A and the ECU 310A is not interrupted. The second cycle can be a cycle different from a cycle of an integer multiple of the first cycle. The communication interruption determination process with respect to the power supply activation-type ECU 310A is the same as the communication interruption determination with respect to the communication activation-type ECU 340A except for the determination cycle.

The fourth determination unit 116 determines whether or not the stop preparation completion notification (second stop preparation completion notification) transmitted from the power supply activation-type ECU has been received by the reception unit 111. That is, the fourth determination unit 116 determines whether or not the frame received by the reception unit 111 is the stop preparation completion notification (second stop preparation completion notification) transmitted from the power supply activation-type ECU.

In a specific example, the fourth determination unit 116 analyzes the frame received by the reception unit 111, and determines whether or not the frame is the stop preparation completion notification transmitted from the power supply activation-type ECU. The fourth determination unit 116 confirms the transmission source of the frame, based on the CAN ID of the received frame, and determines whether or not the transmission source is the power supply activation-type ECU. The fourth determination unit 116 refers to the information stored in the data field of the received frame, and determines whether or not the frame is the stop preparation completion notification. For example, when the stop preparation process performed by the ECU 310A has been completed, a stop preparation completion notification including the CAN ID of the ECU 310A and information indicating the stop preparation completion is transmitted. The fourth determination unit 116 determines that the stop preparation process of the ECU 310A has been completed, by analyzing the stop preparation completion notification.

When the fourth determination unit 116 has determined that the stop preparation completion notification (second stop preparation completion notification) transmitted from the power supply activation-type ECU has been received, the transmission unit 113 transmits information (fourth state notification) for making a notification that the power supply activation-type ECU has transitioned to the stopped state.

For example, the fourth state notification is the state notification frame. Specifically, the fourth state notification is a state notification frame in which the activated state is “OFF” in the state information corresponding to the identification information of the target ECU (the transmission source ECU of the stop preparation completion notification). The transmission unit 113 transmits such a state notification frame to all the ECUs. When the stop preparation process of the ECU 310A has been completed, the identification information of the ECU 310A and the state information in which the activated state is “OFF” are associated with each other in the state notification frame. The transmission unit 113 broadcasts the state notification frame, for example. Therefore, it is possible to notify all the ECUs of the ECU 310A being in the stopped state. Each ECU can identify the ECU 310A being in the stopped state, by analyzing the state notification frame.

When having received the state notification frame (fourth state notification) transmitted from the GW device 100, the ECU in the activated state (e.g., the ECU 330A) ends the communication interruption determination process with respect to the power supply activation-type ECU 310A for which the stop preparation process has been completed. Therefore, it is possible to end the communication interruption determination process with respect to the ECU 310A at the timing when the ECU 310A transitions to the stopped state.

### Operation of In-Vehicle System

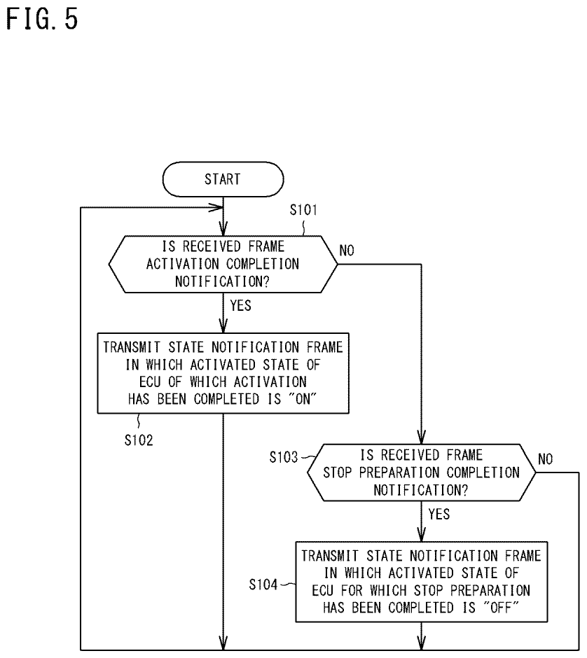

Next, operation of the in-vehicle system 10 according to the embodiment will be described. FIG. 5 is a flowchart showing an example of a state management process in the GW device according to the embodiment. The processor 101 of the GW device 100 executes the state management process as below, using the state management program 110.

The processor 101 determines whether or not the received frame is the activation completion notification (first activation completion notification, second activation completion notification) (step S101).

When the received frame is the activation completion notification (YES in step S101), the processor 101 transmits a state notification frame in which the activated state is “ON” in the state information corresponding to the identification information of the ECU for which the activation sequence has been completed (step S102). After transmitting the state notification frame, the processor 101 returns to step S101.

On the other hand, when the received frame is not the activation completion notification (NO in step S101), the processor 101 determines whether or not the received frame is the standby preparation completion notification or the stop preparation completion notification (step S103). In the following, the standby preparation completion notification and the stop preparation completion notification will also be collectively referred to as “stop preparation completion notification”.

When the received frame is the stop preparation completion notification (YES in step S103), the processor 101 transmits a state notification frame in which the activated state is “OFF” in the state information corresponding to the identification information of the ECU for which the standby preparation process or the stop preparation process has been completed (step S104). After transmitting the state notification frame, the processor 101 returns to step S101.

On the other hand, when the received frame is not the stop preparation completion notification (NO in step S103), the processor 101 returns to step S101.

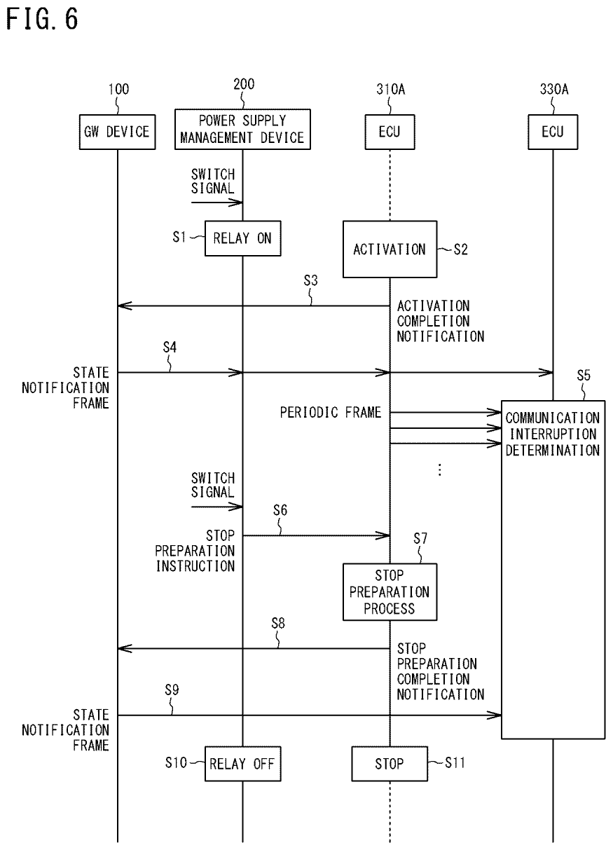

In the following, operation of the in-vehicle system 10 will be described using a specific example. FIG. 6 is a sequence diagram for describing an example of a state management operation with respect to the power supply activation-type ECU in the in-vehicle system according to the embodiment.

When the switch 210 has been pressed and a switch signal (ACC signal, IG signal, +B signal) has been outputted, the power supply management device 200 detects output of the switch signal. The power supply management device 200 switches the relay 460A, 460B, 460C, 460D corresponding to the detected switch signal, to ON (step S1).

For example, when the relay 460A has been switched to ON, the power supply activation-type ECU 310A is activated (step S2). The ECU 310A, upon completion of the activation sequence, transmits the activation completion notification (second activation completion notification) (step S3).

The processor 101 of The GW device 100 determines whether or not the received frame is the activation completion notification.

When the received frame is the activation completion notification, the processor 101 broadcasts a state notification frame in which the activated state is “ON” in the state information corresponding to the identification information of the ECU 310A for which the activation sequence has been completed (step S4).

The transmitted state notification frame is received by the ECU 330A monitoring the communication state. The ECU 330A is an example of “second in-vehicle device”. By receiving the state notification frame, the ECU 330A monitoring the communication state recognizes that the monitoring target ECU is in the activated state, and starts the communication interruption determination process (step S5). In the communication interruption determination process, the ECU 330A receives the periodic frame from the monitoring target ECU 310A, whereby whether or not the communication with respect to the ECU 310A has been interrupted is determined.

When the switch 210 has been pressed and a switch signal has been outputted, the power supply management device 200 detects output of the switch signal. For example, when a switch signal that instructs transition to +B has been detected, the power supply management device 200 transmits an instruction frame for stop preparation, to the power supply activation-type ECU 310A (step S6). The instruction frame is relayed by the GW device 100 from the bus 250C to the bus 250A.

Upon reception of the instruction frame for stop preparation, the ECU 310A executes the stop preparation process (step S7). Upon completion of the stop preparation process, the ECU 310A transmits the stop preparation completion notification (step S8).

The processor 101 of the GW device 100 determines whether or not the received frame is the stop preparation completion notification.

When the received frame is the stop preparation completion notification, the processor 101 broadcasts a state notification frame in which the activated state is “OFF” in the state information corresponding to the identification information of the ECU 310A for which the stop preparation process has been completed (step S9).

The transmitted state notification frame is received by the power supply management device 200. The power supply management device 200 recognizes, through the state notification frame, that the stop preparation of the ECU 310A has been completed, and sets the relay 460A to OFF (step S10). Accordingly, the ECU 310A transitions to the stopped state (step S11).

The transmitted state notification frame is also received by the ECU 330A monitoring the communication state. By receiving the state notification frame, the ECU 330A monitoring the communication state recognizes that the monitoring target ECU is in the stopped state (or a state where the stop preparation process has been completed), and ends the communication interruption determination process (step S5).

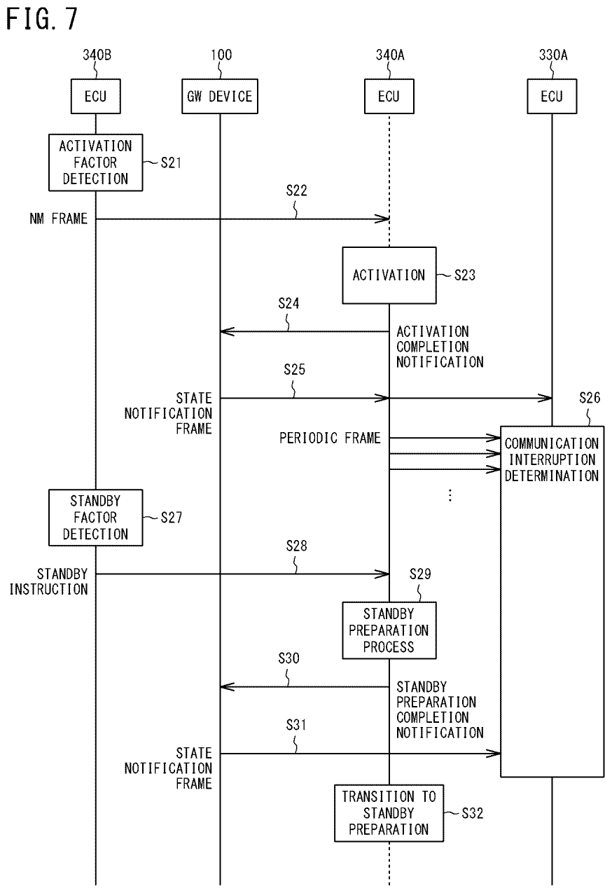

FIG. 7 is a sequence diagram for describing an example of a state management operation with respect to the communication activation-type ECU in the in-vehicle system according to the embodiment.

When a service activation factor, such as input, made by the user to the input device, of an execution start instruction for a specific service, or output of a detection signal of a specific state by a sensor, has been detected (step S21), the communication activation-type ECU transmits an NM frame (step S22). Here, it is assumed that the ECU 340B has transmitted an NM frame designating the PNC to which the ECU 340A belongs. The NM frame is transmitted through the bus 250B to which the ECU 340B is connected, and the GW device 100 relays the NM frame to the bus 250A to which the ECU 340A is connected.

When the communication activation-type ECU 340A has received the NM frame, the ECU 340A is activated (wakes up) (step S23). Upon completion of the activation sequence, the ECU 340A transmits the activation completion notification (first activation completion notification) (step S24).

The processor 101 of The GW device 100 determines whether or not the received frame is the activation completion notification.

When the received frame is the activation completion notification, the processor 101 broadcasts a state notification frame in which the activated state is “ON” in the state information corresponding to the identification information of the ECU 340A for which the activation sequence has been completed (step S25).

The transmitted state notification frame is received by the ECU 330A monitoring the communication state. By receiving the state notification frame, the ECU 330A monitoring the communication state recognizes that the monitoring target ECU is in the activated state, and starts the communication interruption determination process (step S26). In the communication interruption determination process, the ECU 330A receives the periodic frame from the monitoring target ECU 340A, whereby whether or not the communication with respect to the ECU 340A has been interrupted is determined.

When a service standby factor, such as input, made by the user to the input device, of an ending instruction for a specific service, or output of a detection signal of a specific state by a sensor, has been detected (step S27), the ECU 340B transmits a standby instruction frame (step S28). The GW device 100 relays the standby instruction frame from the bus 250B to the bus 250A.

Upon reception of the standby instruction frame, the ECU 340A executes the standby preparation process (step S29). Upon completion of the standby preparation process, the ECU 340A transmits the standby preparation completion notification (step S30).

The processor 101 of the GW device 100 determines whether or not the received frame is the standby preparation completion notification.

When the received frame is the standby preparation completion notification, the processor 101 broadcasts a state notification frame in which the activated state is “OFF” in the state information corresponding to the identification information of the ECU 340A for which the standby preparation process has been completed (step S31).

Upon transmission of the standby preparation completion notification, the ECU 340A quickly transitions to the standby state (step S32).

The transmitted state notification frame is received by the ECU 330A monitoring the communication state. By receiving the state notification frame, the ECU 330A monitoring the communication state recognizes that the monitoring target ECU is in the standby state (or the state where the standby preparation process has been completed), and ends the communication interruption determination process (step S26).

### Modification

In the embodiment described above, the in-vehicle network 250 is configured as a CAN network, but the present invention is not limited thereto. The in-vehicle network 250 may be compatible with a communication protocol such as CAN FD (CAN with Flexible Data Rate), Ethernet (registered trademark), FlexRay (registered trademark), MOST (Media Oriented System Transport) (registered trademark), LIN (Local Interconnect Network), and CXPI (Clock Extension Peripheral Interface) (registered trademark). The in-vehicle network 250 may include both of a CAN network and a network compatible with the above-described communication protocol. In this case, the GW device 100 may have a protocol conversion function between CAN and the above communication protocol.

### Supplementary Note

The above embodiment is merely illustrative in all aspects and is not restrictive. The scope of the present disclosure is defined by the scope of the claims rather than the embodiment described above, and is intended to include meaning equivalent to the scope of the claims and all modifications within the scope.

What is claimed is:

1. An in-vehicle system comprising:
a first in-vehicle device that transitions from a standby state to an activated state through reception of a frame;
a second in-vehicle device configured to be able to communicate with the first in-vehicle device; and
a state management device configured to be able to communicate with the first in-vehicle device and the second in-vehicle device, wherein
the first in-vehicle device transmits a first activation completion notification when the first in-vehicle device has transitioned from the standby state to the activated state,
the state management device includes
a first determination unit configured to determine whether or not the first activation completion notification transmitted from the first in-vehicle device has been received, and
a transmission unit configured to transmit a first state notification when the first determination unit has determined that the first activation completion notification has been received, and
when having received the first state notification transmitted from the state management device, the second in-vehicle device starts a first communication interruption determination process of determining whether or not communication interruption has occurred in the first in-vehicle device.

2. The in-vehicle system according to claim 1, wherein
the first in-vehicle device transmits a first stop preparation completion notification when the first in-vehicle device transitions from the activated state to the standby state,
the state management device further includes
a second determination unit configured to determine whether or not the first stop preparation completion notification transmitted from the first in-vehicle device has been received,
the transmission unit transmits a second state notification different from the first state notification when the second determination unit has determined that the first stop preparation completion notification has been received, and
when having received the second state notification transmitted from the state management device, the second in-vehicle device ends the first communication interruption determination process.

3. The in-vehicle system according to claim 2, wherein
the state management device transmits a state notification frame that includes state information of a plurality of in-vehicle devices,
the first state notification is the state notification frame that includes the state information indicating that the first in-vehicle device is in the activated state, and
the second state notification is the state notification frame that includes the state information indicating that the first in-vehicle device is in the standby state.

4. The in-vehicle system according to claim 1, wherein
the in-vehicle system further comprises
a third in-vehicle device that transitions from a stopped state to an activated state by being supplied with power from a power supply, the third in-vehicle device being configured to be able to communicate with each of the second in-vehicle device and the state management device,
the third in-vehicle device transmits a second activation completion notification when the third in-vehicle device has transitioned from the stopped state to the activated state,
the state management device further includes
a third determination unit configured to determine whether or not the second activation completion notification transmitted from the third in-vehicle device has been received,
the transmission unit transmits a third state notification different from the first state notification when the third determination unit has determined that the second activation completion notification has been received, and
when having received the third state notification transmitted from the state management device, the second in-vehicle device starts a second communication interruption determination process of determining whether or not communication interruption has occurred in the third in-vehicle device.

5. The in-vehicle system according to claim 4, wherein
the third in-vehicle device transmits a second stop preparation completion notification when the third in-vehicle device transitions from the activated state to the stopped state,
the state management device further includes
a fourth determination unit configured to determine whether or not the second stop preparation completion notification transmitted from the third in-vehicle device has been received,
the transmission unit transmits a fourth state notification different from the first state notification and the third state notification when the fourth determination unit has determined that the second stop preparation completion notification has been received, and
when having received the fourth state notification transmitted from the state management device, the second in-vehicle device ends the second communication interruption determination process.

6. The in-vehicle system according to claim 5, wherein
the state management device transmits a state notification frame that includes state information of a plurality of in-vehicle devices,
the first state notification is the state notification frame that includes the state information indicating that the first in-vehicle device is in the activated state,
the third state notification is the state notification frame that includes the state information indicating that the third in-vehicle device is in the activated state, and
the fourth state notification is the state notification frame that includes the state information indicating that the third in-vehicle device is in the stopped state.

7. The in-vehicle system according to claim 1, wherein
the first in-vehicle device transmits a specific first frame in a first cycle in the activated state, and
the first communication interruption determination process is a process of determining whether or not the first frame has been received in a cycle according to the first cycle.

8. The in-vehicle system according to claim 4, wherein
the third in-vehicle device transmits a specific second frame in a second cycle in the activated state, and
the second communication interruption determination process is a process of determining whether or not the second frame has been received in a cycle according to the second cycle.

9. A state management device comprising:
a first determination unit configured to determine whether or not a first activation completion notification transmitted from a first in-vehicle device that transitions from a standby state to an activated state through reception of a frame has been received; and
a first transmission unit configured to transmit, when the first determination unit has determined that the first activation completion notification has been received, a first state notification which serves as a trigger with which a second in-vehicle device configured to be able to communicate with the first in-vehicle device starts a first communication interruption determination process of determining whether or not communication interruption has occurred in the first in-vehicle device.

10. A control method comprising:
a step of transmitting, performed by a first in-vehicle device that transitions from a standby state to an activated state through reception of a frame, a first activation completion notification when the first in-vehicle device has transitioned from the standby state to the activated state;
a step of determining, performed by a state management device configured to be able to communicate with the first in-vehicle device and a second in-vehicle device configured to be able to communicate with the first in-vehicle device, whether or not the first activation completion notification transmitted from the first in-vehicle device has been received;
a step of transmitting, performed by the state management device, a first state notification when the state management device has determined that the first activation completion notification has been received; and
a step of starting, performed by the second in-vehicle device when having received the first state notification transmitted from the state management device, a first communication interruption determination process of determining whether or not communication interruption has occurred in the first in-vehicle device.
